(19) United States
(12) Patent Application Publication
(10) Pub. No.: US 2014/0272520 A1
(43) Pub. Date: Sep. 18, 2014

(54) BATTERY MODULE

(71) Applicant: SAMSUNG SDI CO., LTD., Yongin-si (KR)

(72) Inventor: Duk-Jung KIM, Yongin-si (KR)

(73) Assignee: SAMSUNG SDI CO., LTD., Yongin-si (KR)

(21) Appl. No.: 14/012,208

(22) Filed: Aug. 28, 2013

(30) Foreign Application Priority Data
Mar. 12, 2013 (KR) 10-2013-0026355

(51) Int. Cl. H01M 2/20

(52) U.S. Cl. CPC H01M 2/202; H01M 2/204; H01M 2/206
USPC 429/121; 439/862

(57) ABSTRACT

A battery module includes a plurality of rechargeable batteries, each battery including a first electrode terminal electrically connected with a first electrode and a second electrode terminal electrically connected with a second electrode, and bus bars electrically connecting the rechargeable batteries. The bus bar includes a first contact portion fixed to the first electrode terminal of one rechargeable battery and a second contact portion elastically contacting the second electrode terminal of a neighboring rechargeable battery.

### CROSS-REFERENCE TO RELATED APPLICATION

The present application claims priority under 35 U.S.C. §119 to and benefit of Korean Patent Application No. 10-2013-0026355, filed on Mar. 12, 2013, in the Korean Intellectual Property Office, and entitled: “Battery Module,” which is incorporated by reference herein in its entirety.

### BACKGROUND

1. Field

The described technology relates generally to a battery module having an improved bus bar.

2. Description of the Related Art

Unlike a primary battery, a rechargeable battery may be repeatedly charged and discharged. A rechargeable battery having low capacity is used in portable small electronic devices, e.g., a mobile phone, a laptop computer, a camcorder, and so forth. A rechargeable battery having large capacity is widely used as a power source for a motor, e.g., hybrid vehicles and the like.

The rechargeable battery may be used in small electronic devices as a single-cell battery or as motor power sources as a battery module having a plurality of cells that are electrically connected. The rechargeable battery module is formed by connecting electrode terminals through a bus bar. Such a bus bar is fixed to the electrode terminal by welding, which may not be stable if terminals have different heights.

The above information disclosed in this Background section is only for enhancement of understanding of the background of the described technology and therefore it may contain information that does not form the prior art that is already known in this country to a person of ordinary skill in the art.

### SUMMARY

At least one embodiment is directed to a battery module that includes a plurality of rechargeable batteries, each battery including a first electrode terminal electrically connected with a first electrode and a second electrode terminal electrically connected with a second electrode, and bus bars electrically connecting the rechargeable batteries. Each bus bar includes a first contact portion fixed to the first electrode terminal of one rechargeable battery and a second contact portion elastically contacting the second electrode terminal of its neighboring rechargeable battery

The bus bar may include a connection portion connecting the first contact portion and the second contact portion and located higher than the second contact portion, and the connection portion may have a structure in which different materials are bonded

The connection portion may include a first connection portion made of a first metal and a second connection portion made of a second metal, the first contact portion is made of the first metal and the second contact portion is made of the second metal, and the bus bar may further include a lift portion disposed between the first contact portion and the connection portion. The lift portion is bent in the first contact portion and then inclined.

The second contact portion may include a first elastic plate bent in the connection portion and inclined downward and a second elastic plate bent in the first elastic plate and bent upward, and the second contact portion may be curved in the shape of an arc to protrude toward the second electrode terminal.

The battery module may further include a lower housing to which the rechargeable batteries are inserted and an upper housing covering the lower housing, the upper housing may include pressure protrusions pressing the connection portion toward the rechargeable battery, and the pressure protrusion may be extended along a length direction of the upper housing.

Two pressure protrusions may be disposed at a distance in a width direction of the upper housing in the upper housing, and the first contact portion may be bonded to the first electrode terminal by welding.

The first electrode terminal may include a pillar terminal extending through the first contacting portion, and a nut may be provided on the pillar terminal to fix the first contact portion. The rechargeable battery may include a case and a cap plate coupled to the case, an insulation member is provided between the second electrode terminal and the cap plate for insulation therebetween, and support protrusions may be formed in the insulation member to support the second contact portion.

Hook steps protruding inward towards one another and contacting an upper surface of the second contact portion may be formed in the support protrusions. The bus bar may include a connection portion connecting the first contact portion and the second contact portion and located further higher than the first and second contact portions, and the second contact portion may include a first elastic plate bent in the connection portion and inclined downward and a second elastic plate bent in the first elastic plate and disposed in parallel with the plate terminal.

At least one embodiment is directed to providing a bus bar for electrically connecting neighboring batteries, the bus bar including a first contact portion to be fixed to a first electrode terminal of a first batter and a second contact portion to elastically contact a second electrode terminal of a neighboring battery.

A lowermost surface of the second contact portion may be lower than a lowermost surface of the first contact portion.

The bus bar may include a connection portion connecting the first contact portion and the second contact portion, the connection portion being in a different plane than the first and second contact portions

The connection portion may have a structure in which different materials are bonded. The connection portion may include a first connection portion made of a first metal and a second connection portion made of a second metal, wherein the first contact portion is made of the first metal and the second contact portion is made of the second metal.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view of a battery module according to a first exemplary embodiment.

FIG. 2 illustrates a partial side view of the battery module according to the first exemplary embodiment.

FIG. 3 illustrates a cross-sectional view of FIG. 1, taken along the line

FIG. 4 illustrates a cross-sectional view of a state that the battery module is inserted in a housing according to the first exemplary embodiment.

FIG. 5 illustrates a perspective view of an upper housing of the battery module according to the first exemplary embodiment viewed from the bottom of the upper housing.

FIG. 6 illustrates an exploded partial perspective view of a battery module according to a second exemplary embodiment.

FIG. 7 illustrates a partial side view of the battery module according to the second exemplary embodiment.

FIG. 8 illustrates a cross-sectional view of the battery module according to the second exemplary embodiment.

FIG. 9 illustrates a cross-sectional view of a battery module according to a third exemplary embodiment.

FIG. 10 illustrates a perspective view illustrating a bus bar of the battery module according to the third exemplary embodiment of the present invention.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout.

FIG. 1 illustrates a perspective view of a rechargeable battery module according to a first exemplary embodiment. FIG. 2 is a top plan view of the rechargeable battery module according to the first exemplary embodiment. FIG. 3 illustrates a cross-sectional view of FIG. 1, taken along the line

Referring to FIG. 1 and FIG. 2, a battery module according to the present exemplary embodiment includes a plurality of rechargeable batteries 101 and a plurality of bus bars 120 electrically connecting the rechargeable batteries 101. The rechargeable battery 101 is exemplarily illustrated as a prism-shaped lithium ion secondary battery. However, embodiments disclosed herein are applicable to other various types of batteries, e.g., a lithium polymer battery, a cylindrical battery, and so forth.

Referring to FIG. 1 and FIG. 3, each rechargeable battery 101 includes an electrode assembly 10 performing charging and discharging a current, a case 15 installing the electrode assembly 10 therein, a cap plate 20 coupled to an opening of the case 15, a first electrode terminal (i.e., negative terminal) 21, and a second electrode terminal (i.e., positive terminal) 22. The first electrode terminal 21 and the second electrode terminal 22 are installed in the cap plate 20.

The electrode assembly 10 may be formed by disposing a first electrode (hereinafter referred to as a negative electrode) 11 and a second electrode (hereinafter referred to as a positive electrode) 12 at respective surfaces of a separator 13, which is an insulator, and spiral-winding the negative electrode 11, the separator 13, and the positive electrode 12 in a jelly roll shape.

The negative electrode 11 and the positive electrode 12 may include a current collector of metal having coated portions 11a and 12a with an active material thereon and uncoated portions 11b and 12b which expose the current collector.

The uncoated portion 11b of the negative electrode 11 is formed at one end of the negative electrode 11 along the wound negative electrode 11. The uncoated portion 12b of the positive electrode 12 is formed at one end of the positive electrode 12 along the wound positive electrode 12. The uncoated portions 11b and 12b are disposed at opposite ends of the electrode assembly 10.

The case 15 may be shaped like an approximate cuboid to provide a space for receiving the electrode assembly 10. An opening of the case 15 is formed at one side of the cuboid so that the electrode assembly 10 can be inserted into the case 15.

The cap plate 20 seals the case 15 by being provided in the opening of the case 15. The case 15 and the cap plate 20 may be formed of same material, e.g., aluminum, so that they may be welded to each other.

In addition, the cap plate 20 is provided with an electrolyte injection opening 29, a vent hole 24, and terminal holes H1 and H2. The electrolyte injection opening 29 allows injection of the electrolyte solution into the case 15 after the cap plate 20 is coupled to the case 15. After the electrolyte solution has been injected, the electrolyte injection opening 29 is sealed, e.g., by a sealing cap 27.

The vent hole 24 is sealed by a vent plate 25 so as to discharge internal pressure of the rechargeable battery 100 due to internal gas. When the internal pressure of the rechargeable battery 100 reaches a predetermined level, the vent plate 25 is ruptured to open the vent hole 24. The vent plate 25 may include a notch 25a that induces the rupture.

A first electrode terminal 21 and a second electrode terminal 22 are respectively provided in the terminal holes H1 and 142 of the cap plate 20, and are electrically connected to the electrode assembly 10. In particular, the first electrode terminal 21 is electrically connected to the negative electrode 11 of the electrode assembly 10 and the second electrode terminal 22 is electrically connected to the positive electrode 12 of the electrode assembly 10. Thus, the electrode assembly 10 accessible to the outside of the case 15 through the first electrode terminal 21 and the second electrode terminal 22.

When the first electrode terminal 21 and the second electrode terminal 22 have the same structure as each other at the inside of the cap plate 20, the same structure will be described together, and, when the first electrode terminal 21 and the second electrode terminal 22 have different structures from each other at the outside of the cap plate 20, the different structures will be separately described.

The first and second electrode terminals 21 and 22 may include rivet terminals 21a and 22a installed at the terminal holes H1 and H2 of the cap plate 20, respectively, flanges 21b and 22b that are integral with and wider than the rivet terminals 21a and 22a inside of the cap plate 20, and plate terminals 21c and 22c disposed at the outside of the cap plate 20 to be connected to the rivet terminals 21a and 22a, e.g., by riveting or welding.

Negative and positive gaskets 36 and 37 are installed between the rivet terminals 21a and 22a of the negative and positive terminals 21 and 22, and the inner surfaces of the terminal holes H1 and H2 of the cap plate 20, respectively, to seal and establish electrical connection between the rivet terminals 21a and 22a of the first and second electrode terminals 21 and 22 and the cap plate 20.

The negative and positive gaskets 36 and 37 further extend between the flanges 21b and 22b and the inner surface of the cap plate 20 to further seal and establish electrical connection between the flanges 21b and 22b and the cap plate 20. That is, the negative and positive gaskets 36 and 37 seal the first and second electrode terminals 21 and 22 at the cap plate 20, thereby preventing the electrolyte solution from leaking through the terminal holes H1 and H2.

A negative electrode lead tab 51 and a positive electrode lead tab 52 electrically connect the first electrode terminal 21 and the second electrode terminal 22 to the negative electrode 11 and the positive electrode 12 of the electrode assembly 10, respectively. Support protrusions 21d and 22d may be formed in lower ends of the rivet terminals 21a and 22a, may be fixed by welding to the negative electrode lead tab 51 and the positive electrode lead tab 52.

A negative electrode insulation member 61 and a positive electrode insulation member 62 re respectively provided between the negative electrode lead tab 51 and the cap plate 20 and between the positive electrode lead tab 52 and the cap plate 20 for electrical insulation therebetween. In addition, the negative electrode insulation member 61 and the positive electrode insulation member 62 are coupled to the cap plate 20 at one side and surround the negative and positive electrode lead tabs 51 and 52, the rivet terminals 21a and 22a, and the flanges 21b and 22b at the other side, thereby stabilizing a connection structure thereof.

The terminal plate 21c of the first electrode terminal 21 is electrically connected to the rivet terminal 21a and disposed to the outside of the cap plate 20 by providing an insulation member 31 therebetween. The insulation member 31 is provided between the terminal plate 21c and electrically insulate the terminal plate 21c and the cap plate 20. That is, the cap plate 20 maintains a state of being electrically insulated from the first electrode terminal 21.

The top plate 32 in the second electrode terminal 22 side electrically connects the plate terminal 22c of the second electrode terminal 22 and the cap plate 20. For example, the top plate 32 is provided between the plate terminal 22c and the cap plate 20, and the rivet terminal 22a penetrates therethrough.

Thus, the top plate 32 and the plate terminal 22c are coupled to the upper end of the rivet terminal 22a and the upper end is sealed, e.g., caulked, such that the top plate 32 and the plate terminal 22a are coupled to the upper end of the rivet terminal 22a. The plate terminal 22c is provided in the outer side of the cap plate 20 while interposing the top plate 32 therebetween. The positive electrode gasket 37 may further extend between the rivet terminal 22a and the top plate 32.

As shown in FIG. 2, the bus bar 120 includes a first contact portion 121 fixed to the second electrode terminal 22, a second contact portion 125 electrically contacting the first electrode terminal 21, and a connection portion 123 connecting the first contact portion 121 and the second contact portion 125. In addition, a lift portion 124 provided between the first contact portion 121 and the connection portion 123 is bent from the first contact portion 121 and inclined upward, i.e., away from the second electrode terminal 22, with respect to the first contact portion 121.

The first contact portion 121 is parallel with the second electrode terminal 22 and bonded to the second electrode terminal 22, e.g., by welding. The connection portion 123 has a structure in which two different types of materials are bonded to each other. In particular, the connection portion 123 includes a first connection plate 123a formed of a first material, e.g., aluminum, and a second connection plate 123b formed of a second material, e.g., copper.

The bus bar 120 may have a structure of a clad metal formed by bonding copper and aluminum or a structure in which copper and aluminum are friction-welded. The first contact portion, the lift portion 124, and the first connection plate 123a may all be made of the first material, e.g., aluminum, and the second contact portion 125 and the second connection plate 123b may be made of the second material, e.g., copper. The first electrode terminal 21 is made of the second material, e.g., copper, and the second electrode terminal is made of the first material, e.g., aluminum, such that the second contact portion 125 and the first electrode terminal 21 are made of the same material and the first contact portion 121 and the second electrode terminal 22 are made of the same material. Accordingly, the same materials contact each other so that welding can be readily performed and corrosion that results from bonding different materials can be prevented.

The second contact portion 125 may include a first elastic plate 125a bent from the connection portion 123 and inclined downward, i.e., closer to the first electrode terminal 22, with respect to the connection portion 123 and a second elastic plate 125b bent from the first elastic plate 125a and inclined upward, i.e., further from the first electrode terminal 21, with respect to the first elastic plate 125a. As indicated by the dotted line in FIG. 2, the lower end of the second contact portion 125 is formed to be located below an upper surface of the first contact portion 121, such that when the second contact portion 125 contacts the first electrode terminal 21, the second contact portion 125 is elastically deformed to contact the upper surface of the first electrode terminal 21. Thus, the interface between the first elastic plate 125a and the second elastic plate 125b faces and contacts the first electrode terminal 21.

As described, according to the present exemplary embodiment, the first contact portion is bonded to the terminal by welding and the second contact portion contacts the terminal in an elastically deformed manner so that the bus bar can be stably installed even if the terminals have different heights.

When the bus bar is formed in the shape of a flat plate, it is not easy to perform welding or fix using a nut if terminals have different heights. In addition, even after welding is performed, a welding failure may occur due to a restoring force. When both ends of the bus bar elastically contact the terminal, contact resistance is increased and excessive stress is applied to the bus bar.

However, the bus bar having a hybrid structure in which one end of the bus bar is bonded to a terminal by welding and the other end elastically contacts the terminal as described above can be easily installed and the contact resistance can be reduced.

FIG. 4 illustrates a cross-sectional view of a state that the rechargeable batteries according to the first exemplary embodiment are inserted into a housing. FIG. 5 illustrates a perspective view of an upper housing of the battery module, viewed from the bottom of the housing, according to the first exemplary embodiment. Referring to FIG. 4 and FIG. 5, the battery module further includes a lower housing 130 to which the rechargeable batteries 101 are inserted and an upper housing 140 covering the lower housing 130.

In the upper housing 140, pressure protrusions 141 and 142 closely attaching the bus bar 120 to the first electrode terminal 21 by pressing the bus bar 120. The pressure protrusions 141 and 142 extend in a length direction from the upper housing 140. The two pressure protrusions 141 and 142 are separated along a width direction of the upper housing 140 and are thus disposed at both edges in the width direction of the upper housing 140. The pressure protrusions 141 and 142 contact the upper surface of the connection portion 123 and press down on the connection portion 123. Accordingly, the second contact portion 125 and the first electrode terminal 21 maintain a closely attached state.

When only the welded first contact portion 121 supports the second contact portion 125 to be maintained in the deformed state, stress is applied to the first contact portion 121, which may result in a welding failure. However, as in the present exemplary embodiment, when the pressure protrusions 141 and 142 are formed in the upper housing 140, the second contact portion 125 can be stably supported and closely attached to the first electrode terminal 21, reducing stress applied to the first contact portion 121.

FIG. 6 illustrates a perspective partial view of a battery module according to a second exemplary embodiment. FIG. 7 is a cross-sectional partial view of the battery module according to the second exemplary embodiment. FIG. 8 is a cross-sectional view of the battery module according to the second exemplary embodiment.

Referring to FIG. 6 to FIG. 8, a battery module according to the present exemplary embodiment is the same as the battery module according to the first exemplary embodiment, except for a structure of a bus bar 150 and an insulation member 160, and therefore a description for the same structure will not be further provided.

Since a rechargeable battery 102 has a plate terminal 22c, an insulation member 160 is provided in a lower portion of the plate terminal 22c. Support protrusions 162 and 163 may be provided to keep the bus bar 150 in contact with the second electrode terminal 22. The insulation member 160 is provided instead of a top plate and, accordingly, the neutrality of the case 15 is maintained.

The insulation member 160 may include an insulation plate 161 provided in a lower portion of the plate terminal 22c and support protrusions 162 and 163 protruding upward from lateral side ends of the insulation plate 161. Hook steps 162a and 163a protruding inward towards each other may be formed in the support protrusions 162 and 163. The hook steps 162a and 163a contact the upper surface of bus bar 150 and support the bus bar 150. Thus, the bus bar 150 can maintain a deformed state by the support of the hook steps 162a and 163a.

The bus bar 150 include a first contact portion 151 bonded to the first electrode terminal 21 by welding, a second contact portion 155 elastically contacting the second electrode terminal 22, and a connection portion 152 connecting the first contact portion 151 and the second contact portion 155. In addition a lift portion 153 bent from the first contact portion 151 and inclined upward, i.e., further from the first electrode terminal 21, with respect to the first contact portion 151 is provided between the first contact portion 151 and the contact portion 152.

The connection portion 152 may have a structure in which two different types of materials are bonded to each other. In particular, the connection portion 152 includes a first connection plate 152a formed of a first material, e.g., aluminum, and a second connection plate 152b formed of a second material, e.g., copper.

The bus bar 150 may have a structure of a clad metal formed by bonding copper and aluminum or a structure in which copper and aluminum are friction-welded. The first contact portion 151, the lift portion 153, and the first connection plate 152a may all be made of the first material, e.g., aluminum, and the second contact portion 155 and the second connection plate 152b may be made of the second material, e.g., copper. The first electrode terminal 21 is made of the second material, e.g., copper, and the second electrode terminal 22 is made of the first material, e.g., aluminum, such that the second contact portion 155 and the first electrode terminal 21 are made of the same material and the first contact portion 151 and the second electrode terminal 22 are made of the same material. Accordingly, the same materials contact each other so that welding can be readily performed and corrosion that results from bonding different materials can be prevented.

The second contact portion 155 includes a first elastic plate 155a bent from the connection portion 152 and inclined downward with respect to the connection portion 152 and a second elastic plate 155b bent from the first elastic plate 155a and parallel with the plate terminal 22c. The second elastic plate 155b is fixed to the support protrusions 162 and 163 by being fitted therein.

As shown in FIG. 7, when the pressure protrusion 141 of the upper housing 140 presses down the connection portion 152, the bus bar 150 is deformed and, thus, the second contact portion 155 is closely attached to the plate terminal 22c and the support protrusions 162 and 163 keep the second contact portion 155 to maintain the state of being closely attached to the plate terminal 22c.

As described above, according to the present exemplary embodiment, the support protrusions 162 and 163 and the pressure protrusions 141 and 142 support the second contact portion 155 to maintain the elastically deformed state, and therefore the second contact portion 155 and the terminal plate 21c can further stably contact each other.

FIG. 9 illustrates a cross-sectional view of a battery module according to a third exemplary embodiment. FIG. 10 illustrates a perspective view of a bus bar of the battery module according to the third exemplary embodiment.

Referring to FIG. 9 and FIG. 10, the battery module according to the present exemplary embodiment is the same as the battery module of the first exemplary embodiment, except for a structure of a first electrode terminal 321 and a bus bar 160, and therefore a description for the same structure will not be provided.

A bus bar 180 electrically connecting rechargeable batteries 103 may include a first contact portion 181 coupled to a first electrode terminal 321, a second contact portion 185 elastically contacting the second electrode terminal 22, and a connection portion 182 connecting the first contact portion 181 and the second contact portion 185. In addition, a lift portion 183 bent from the first contact portion 181 and inclined upward with respect to the first contact portion 181 may be provided between the first contact portion 181 and the connection portion 182.

The connection portion 182 may have a structure in which two different types of materials are bonded to each other. In particular, the connection portion 182 includes a first connection plate 182a formed of a first material, e.g., aluminum, and a second connection plate 182b formed of a second material, e.g., copper.

The bus bar 180 may have a structure of a clad metal formed by bonding copper and aluminum or a structure in which copper and aluminum are friction-welded. The first contact portion 181, the lift portion 183, and the first connection plate 182a may all be made of the first material, e.g., aluminum, and the second contact portion 185 and the second connection plate 182b may be made of the second material, e.g., copper. The second electrode terminal 22 is made of the second material, e.g., copper, and the first electrode terminal 321 is made of the first material, e.g., aluminum, such that the second contact portion 185 and the second electrode terminal 22 are made of the same material and the first contact portion 181 and the first electrode terminal 321 are made of the same material. Accordingly, the same materials contact each other so that welding can be readily performed and corrosion that results from bonding different materials can be prevented.

The first contact portion 181 may include a hole 181a through which a pillar terminal 321a extends. The second contact portion 185 may be a curved structure, e.g., in the shape of an arc, that protrudes toward the terminal. A lowermost surface of the second contact portion 185 is disposed below a lowermost surface of the first contact portion 181. Since the second contact portion 185 is curved toward the terminal, the second contact portion 185 is deformed when contacting the second electrode terminal 22 as indicated by the dotted line of FIG. 10, and thus is closely attached to the second electrode terminal 22.

The first electrode terminal 321 includes the pillar terminal 321a provided in a terminal hole H1 of a cap plate 20, a flange 321b integral with and wide than the pillar terminal 321a in the inside of the cap plate 20, and a plate terminal 321c provided in the outer side of the cap plate 20 through which the pillar terminal 321a penetrates. A support protrusion 321d may be formed in a lower end of the pillar terminal 321a and may be fixed, e.g., welded, to the negative electrode lead tab 51.

The pillar terminal 321a protrudes upward through the plate terminal 321c and the first contact portion 181. An upper end of the plate terminal 321c may be screw-processed to form a screw thread thereon. In addition, a nut 39 is provided in the pillar terminal 321a to press the first contact portion 181 with the plate terminal 321c.

As described, according to the present exemplary embodiment, the first contact portion 181 is fixed to the first electrode terminal 21 using the nut 39 and the second contact portion 185 contacts the second electrode terminal 22 in an elastically deformed manner.

By way of summation and review, battery modules according to the exemplary embodiments have a first side of the bus bar bonded to a first terminal, e.g., by welding, and a second side of the bus bar elastically contacting a second terminal. Such a bus bar may be easily installed, even if heights of the first and second terminals are different.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. For example, the screw and nut configuration of the third embodiment may be used with the elastic contact configurations of the first and second embodiments. Accordingly, it will be understood by those of skill in the art that various changes in form and details may be made without departing from the spirit and scope of the present invention as set forth in the following claims.

What is claimed is:

1. A battery module, comprising:
a plurality of rechargeable batteries, each battery including a first electrode terminal electrically connected with a first electrode and a second electrode terminal electrically connected with a second electrode; and
bus bars electrically connecting the rechargeable batteries,
wherein each bus bar includes a first contact portion fixed to the first electrode terminal of one rechargeable battery and a second contact portion elastically contacting the second electrode terminal of a neighboring rechargeable battery.

2. The battery module as claimed in claim 1, wherein each bus bar comprises a connection portion connecting the first contact portion and the second contact portion, the connection portion being further from the batteries than the first and second contact portions.

3. The battery module as claimed in claim 2, wherein the connection portion has a structure in which different materials are bonded.

4. The battery module as claimed in claim 3, wherein the connection portion includes a first connection portion made of a first metal and a second connection portion made of a second metal, wherein the first contact portion is made of the first metal and the second contact portion is made of the second metal.

5. The battery module as claimed in claim 2, wherein the bus bar further comprises a lift portion between the first contact portion and the connection portion, the lift portion being inclined and extending from the first contact portion.

6. The battery module as claimed in claim 2, wherein the second contact portion comprises a first elastic plate bent from the connection portion and inclined downward and a second elastic plate bent from the first elastic plate and bent upward.

7. The battery module as claimed in claim 2, wherein the second contact portion is a curved surface that protrudes toward the second electrode terminal.

8. The battery module as claimed in claim 2, further comprising:
a lower housing to which the rechargeable batteries are inserted; and
an upper housing covering the lower housing, wherein the upper housing includes pressure protrusions pressing the connection portion toward the rechargeable battery.

9. The battery module as claimed in claim 8, wherein the pressure protrusion extends along a length direction of the upper housing.

10. The battery module as claimed in claim 9, wherein two pressure protrusions are disposed at a distance in a width direction of the upper housing in the upper housing.

11. The battery module as claimed in claim 1, wherein the first contact portion is bonded to the first electrode terminal by welding.

12. The battery module as claimed in claim 1, wherein the first electrode terminal comprises a pillar terminal protruding through the first contact portion, wherein a nut is provided on the pillar terminal to fix the first contact portion.

13. The battery module as claimed in claim 1, wherein the rechargeable battery comprises:
a case;
a cap plate coupled to the case;
an insulation member between the second electrode terminal and the cap plate; and
support protrusions extending from the insulation member to support the second contact portion.

14. The battery module as claimed in claim 13, wherein the support protrusions include hook steps extending there from and protruding inward towards each other, the hook steps contacting an upper surface of the second contact portion.

15. The battery module as claimed in claim 14, wherein each bus bar comprises:
a connection portion connecting the first contact portion and the second contact portion, the connection portion being higher than the first and second contact portions, wherein the second contact portion includes a first elastic plate bent from the connection portion and inclined downward and a second elastic plate bent from the first elastic plate and in parallel with the plate terminal.

16. A bus bar for electrically connecting neighboring batteries, the bus bar comprising:
a first contact portion to be fixed to a first electrode terminal of a first battery; and
a second contact portion to elastically contact a second electrode terminal of a neighboring battery.

17. The bus bar as claimed in claim 16, wherein a lowermost surface of the second contact portion is lower than a lowermost surface of the first contact portion.

18. The bus bar as claimed in claim 16, further comprising a connection portion connecting the first contact portion and the second contact portion, the connection portion being in a different plane than the first and second contact portions

19. The bus bar as claimed in claim 18, wherein the connection portion has a structure in which different materials are bonded.

20. The bus bar as claimed in claim 19, wherein the connection portion includes a first connection portion made of a first metal and a second connection portion made of a second metal, and wherein the first contact portion is made of the first metal and the second contact portion is made of the second metal.
